(19) United States
(12) Patent Application Publication
(10) Pub. No.: US 2026/0113335 A1
(43) Pub. Date: Apr. 23, 2026

(54) Methods and Systems for Detecting Compromised Accounts and/or Attempts to Compromise Accounts

(71) Applicant: Xero Limited, Te Aro, Wellington (NZ)

(72) Inventors: Justin Thirkell, Te Aro, Wellington (NZ); Soon-Ee Cheah, Te Aro, Wellington (NZ)

(21) Appl. No.: 18/881,151

(22) PCT Filed: Jun. 26, 2023
(86) PCT No.: PCT/NZ2023/050061

§ 371 Date: Jan. 3, 2025

(30) Foreign Application Priority Data
Jul. 5, 2022 (AU) 2022901892

(51) Int. Cl. H04L 9/40

(52) U.S. Cl. CPC H04L 63/1416

(57) ABSTRACT

Please replace the abstract with the following abstract:

A method includes determining, from an event store, a compromised account dataset and an uncompromised account dataset, and determining from the datasets, a training dataset. The training dataset comprises examples from the compromised account dataset and examples from the uncompromised account dataset, at least some of which comprise a label indicative of a security risk or no security risk, respectively. The method comprises determining a set of attributes from the examples, and determining a numerical representation of each set of attributes. The method comprises training a compromised account detection model using the numerical representations and the labels to predict a likelihood of a candidate user account being a security risk and providing the trained compromised account detection model.

### TECHNICAL FIELD

Described embodiments relate to computing systems and computer-implemented methods for detecting compromised accounts and/or attempts to compromise accounts, and in some embodiments, in response to detecting compromised accounts and/or attempts to compromise accounts, taking proactive action.

### BACKGROUND

Known computer implemented techniques for monitoring user accounts used by security systems tend to be generic and rely on a set of standard or “one size fits all” security rules and/or metrics. For example, some prior art security systems attempt to determine malicious activity on a user account of a computer system by comparing a login attempt with a set of generic rules to determine the validity of the login attempt.

It is desired to address or ameliorate some of the disadvantages associated with such prior methods and systems, or at least to provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer-implemented method comprising: determining, from an event store, a compromised account dataset comprising compromised user account examples, each compromised user account example being associated with a user account that has been compromised or has been subjected to an attempted security breach, and comprising a first plurality of event objects; determining, from the event store, an uncompromised account dataset comprising uncompromised user account examples, each uncompromised user account example being associated with a user account that has not been compromised and has not been subjected to an attempted security breach, and comprising a second plurality of event objects; determining a training dataset, the training data set comprising a plurality of compromised user account examples from the compromised account dataset and a plurality of uncompromised user account examples from the uncompromised account dataset, wherein one or more of the compromised user account examples comprise a label indicative of a security risk, and one or more of the uncompromised user account examples comprise a label indicative of no security risk; determining a set of attributes from each of the plurality of compromised user account examples and the plurality of uncompromised user account examples; determining a numerical representation of each set of attributes, wherein at least some of the numerical representations are associated with the respective label of the compromised or uncompromised user account examples from which the associated set of attributes was determined; training a compromised account detection model using the numerical representations and the labels to predict a likelihood of a candidate user account being a security risk; and providing the trained compromised account detection model.

In some embodiments, the user accounts of the examples of the comprised account dataset and the uncompromised account dataset are associated with a same user role type attribute.

In some embodiments, the user accounts of the examples of the comprised account dataset and the uncompromised account dataset are associated with a plurality of different user role type attributes.

In some embodiments, a first feature values of each of the numerical representations of the plurality of compromised user account examples and the plurality of uncompromised user account examples user is a role type attribute value.

In some embodiments, the user role type attribute comprises a dual or multi role value.

In some embodiments, the one or more attributes determined from the uncompromised user account examples are indicative of standard user behaviours for the user role type attribute and the one or more attributes determined from the compromised user account examples are indicative of non-standard and/or anomalous user behaviours for the user role type attribute.

In some embodiments, the training of the compromised account detection model comprises: a sliding window data selection process.

In some embodiments, the adaptive sliding window selection method comprises: determining one or more account example subsets of the uncompromised account dataset and/or the compromised account dataset; and determining one or more attribute subsets from each of the plurality of compromised user account examples and each of the plurality of uncompromised user account examples in the one or more account example subsets.

In some embodiments, the adaptive sliding window selection method comprises: determining one or more attribute subsets of the one or more attributes.

In some embodiments, the one or more attribute subsets are determined based on one or more of: time of day, business hours, user role type and/or periods of high activity.

In some embodiments, the compromised account detection model is trained using the one or more attribute subsets. In some embodiments, the training of the compromised account detection model comprises: a semi-supervised learning process.

In some embodiments, determining the numerical representation of each set of attributes comprises: encoding one or more of the attributes into an ordinal encoding, wherein the ordinal encoding is indicative of a sequential relationship between each of the plurality of compromised user account examples and wherein the ordinal encoding is indicative of a sequential relationship between each of the plurality of uncompromised user account examples.

In some embodiments, the method further comprises: generating one or more artificial compromised account examples using a generative machine learning model.

Some embodiments are related to a computer implemented method comprising: responsive to receiving a trigger request associated with a user account, determining, from an event log of the user account at an event store, a user account dataset, the user account dataset comprising a plurality of event objects; determining, from the plurality of event objects, a set of attributes; determining a numerical representation of the set of attributes; providing, to a compromised account detection model, the numerical representation, the compromised account detection model configured to predict user account security risks; and outputting, by the compromised account detection model, an indication of whether the user account is compromised or whether the user account has been subjected to a potential security breach.

In some embodiments, a first feature value of the numerical representation comprises an indication of a user role type attribute value.

In some embodiments, the method further comprises: determining a user role type attribute value associated with the user account; and selecting the compromised account detection model from a plurality of compromised account detection models based on the user role type attribute value, wherein the selected compromised account detection model is configured to output an indication of whether the user account is compromised or whether the user account has been subjected to a potential security breach specific to the determined user role type attribute.

In some embodiments, the indication of whether the user account is compromised or whether the user account has been subjected to a potential security breach comprises: determining that the user account dataset is indicative of user behaviour that is non-standard.

In some embodiments, the trigger request is one of: an access credential request; an automatic compromised account check request; or a manual compromised account check request

In some embodiments, the compromised account detection model is trained according to any of the described methods.

In some embodiments, the one or more attributes comprise or are indicative of one or more of: authentication/authorisation request type; authentication/authorisation request time; authentication/authorisation request frequency; authentication/authorisation request originating location; local time of the authentication/authorisation request originating location; password strings; email addresses; two-factor authentication/authorisation information; request device identifier; business hours; and high network traffic times.

Some embodiments relate to a system comprising: memory having instructions embodied thereon; and one or more processors configured by the instructions to perform any of the described methods.

Some embodiments relate to a non-transitory machine-readable storage medium storing instructions which, when executed by one or more processors, cause the one or more processors to perform any one of the described methods.

### BRIEF DESCRIPTION OF DRAWINGS

Some embodiments will now be described by way of non-limiting examples with reference to the accompanying drawings.

FIG. 1 is a block diagram of a system for monitoring accounts of computer systems, according to some embodiments;

FIG. 2 is a process flow diagram for a method of training a machine learning model, according to some embodiments; and

FIG. 3 is a process flow diagram for a method of monitoring accounts of computer systems, according to some embodiments.

### DESCRIPTION OF EMBODIMENTS

Described embodiments relate to computing systems and computer-implemented methods for detecting compromised accounts and/or attempts to compromise accounts, and in some embodiments, in response to detecting compromised accounts and/or attempts to compromise accounts, taking proactive action.

Some embodiments involve monitoring user accounts, such as user accounts of platform facilitated or provided by computer systems or servers and/or assessing user accounts to determine whether the account has been compromised, or is in danger of being compromised.

Described embodiments relate to the use of eventing or event sourcing to facilitate the monitoring of user accounts of computer systems such as authentication and/or authorisation servers, for example. Event sourcing is a database configuration approach that facilitates the tracking of not only a current state of a system, but also of an entire sequence of state transitions, or history of state transitions (i.e. events) that led to the current state. The events are the “source of truth” of the system from which the current state, or any past state is inferred.

In some embodiments, a security system may be configured to monitor user accounts associated with an authentication and/or authorisation server, to detect if and/or when one or more user accounts become compromised, or an attempt is made by a malicious actor to compromise account(s). A compromised account may be an account that has been successfully infiltrated by a malicious actor, and for example, where control of the account is no longer vested in the account owner and/or the administrator of the computer system that originally issued the account.

A compromised account dataset may be stored in a database and accessible to a computer system, such as the security system. The computer system may comprise a compromised account detection module configured to train a machine learning (ML) model to predict compromised user accounts and/or attempts to comprise user accounts using the compromised account dataset. The compromised account dataset may comprise a plurality of compromised user account examples, each example comprising a plurality of event objects associated with a user whose account has been compromised or has been subjected to a compromise attempt. In some embodiments, the compromised account detection module may also use an uncompromised account dataset to train the ML model. The uncompromised account dataset may comprise a plurality of uncompromised user account examples, each example comprising a plurality of event objects associated with a user whose account has not been compromised, and/or has not been subjected to a compromise attempt.

In some embodiments, the computer system may be configured to generate the compromised account dataset and/or the uncompromised account dataset (collectively the training dataset) by traversing or replaying event logs associated with user accounts as stored in an event store.

In some embodiments, the compromised account detection module may be configured to train the ML model to detect compromised user accounts and/or attempts to comprise user accounts. The training set may comprise examples from the compromised account dataset and examples from the uncompromised account dataset. Features, attributes or attribute values may be derived or extracted from the event objects of the examples and provided as inputs to the ML model. In some embodiments, the target of the ML may be to indicate whether the example is one of a compromised account or an attempt to compromise an account (e.g. a security risk), or whether the example one of an uncompromised account (e.g. no security risk). In some embodiments, the target of the ML model may be to indicate whether the example is indicative of, or describes, standard or non-standard/anomalous user behaviours, such as user authentication requests and/or user authorisation and/or access request tendencies. Standard or non-standard/anomalous user behaviours may be indicative of whether the normal or usual user of an account is or is not who or what is using, requesting access and/or accessing the user account.

In some embodiments, for example, the features may comprise quantities and/or qualities of the event objects associated with an account. Qualities of the event objects may comprise the type of request, e.g. access requests or read and/or write requests, and the data values associated with these requests, e.g. new password strings and/or new email addresses. Once trained, the ML model of the compromised account detection module may be configured to receive as inputs, attributes and/or attribute values derived from event objects of a candidate user account event log, and provide as an output, an indication of whether or not the account is a security risk. In some embodiments, the account detection module may be configured to determine, based on the attributes and/or attribute values of the examples, a set of compromise indicators (for example, metrics) indicative of whether or not an account is a security risk.

In some embodiments, the account detection module may be configured to provide as an output an indication of whether the behaviour associated with the candidate account is similar, or substantially similar to standard, or regular behaviours associated with that account. The account detection module may be configured to provide as an output an indication of whether the behaviour associated with the candidate account is anomalous. The account detection module may also be configured to determine, and in some embodiments, provide as an output, an indication of whether the behaviour associated with the candidate account is not similar, or not substantially similar to standard, or regular behaviours associated with that account. In some embodiments, the account detection module may be configured to determine and in some embodiments, provide as an output, an indication of whether or not an account is a security risk based on the determined indication of whether the behaviour associated with the candidate account is not similar, or not substantially similar to standard, or regular behaviours associated with that account.

Responsive to the receipt of a trigger request associated with a user, such as a new authentication or authorisation request, or a security breach monitoring trigger, the security system may traverse all, or a subset of all event logs associated with the user to determine a user account dataset of event objects.

Subsequent to determining the user account dataset, the security system may determine, from the user account event dataset, one or more account attribute values, such as number of login attempts, type of login attempt, number of password changes, number of previous passwords, password change frequency, password generation tendencies and/or time of the authentication and/or authorisation request, for example. In some embodiments, the security system may provide the attributes values as inputs to the trained compromised account detection module and determine, as an output, an indication of whether or not the account is a security risk. In some embodiments, the security system may perform a comparison between the attribute values and the set of compromise indicators determined by the compromised account detection module to determine whether one or more user account exhibits similar patterns in their event logs as accounts that were known to be compromised. Upon determining that a candidate user account is likely to be compromised and/or is in danger of being compromised, the security system may send an alert indicating as such, and/or may take a proactive security measure, such as suspending or temporarily locking the user account.

Described embodiments may be implemented in several capacities, individually or simultaneously, to form a security network to protect the integrity of the authentication and/or authorisation server. In some embodiments, the security system may be configured to monitor new requests to read from and/or write to the authentication and/or authorisation server, and which may act as the trigger request to perform the security operation.

In some embodiments, the security system may be configured to monitor the event logs periodically, aperiodically and/or upon instruction. For example, the trigger request to perform the security operation may comprise receipt of a request from an administrator, or a programmed periodic or aperiodic request.

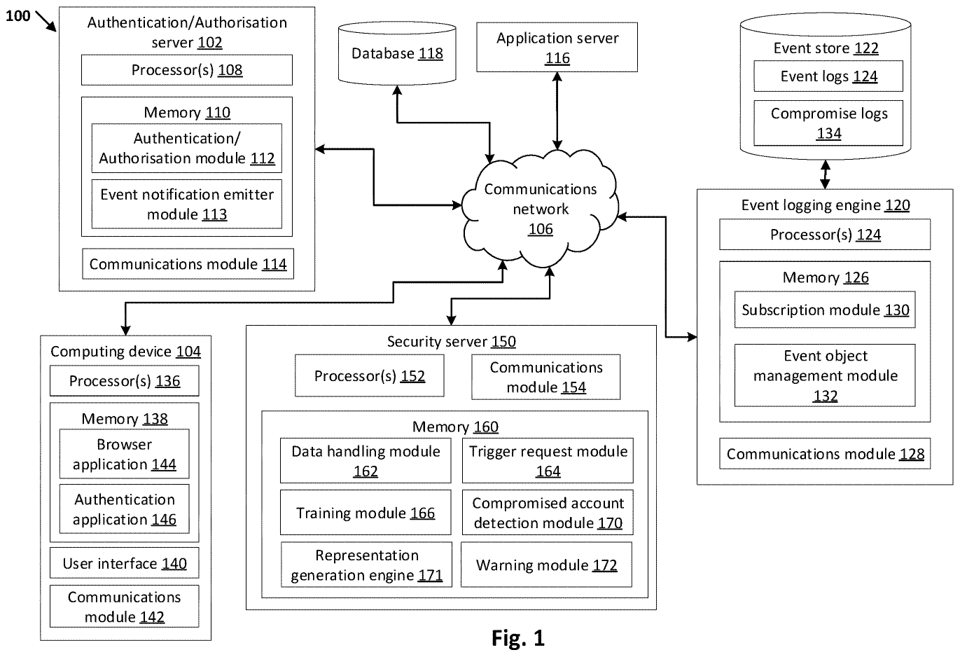

Referring now to FIG. 1, there is shown a block diagram of system 100, for detecting compromised accounts and/or attempts to compromise accounts, according to some embodiments.

As illustrated, the system 100 comprises a security server 150, arranged to communicate, over a communications network 106, with one or more authentication/authorisation servers 102, one or more computing device 104, one or more application servers 116, one or more databases 118 and/or one or more event logging engines 120. For example, security server 150 may be configured to receive event objects from event logging engine 120 and/or database 118 and/or receive event notifications from authentication/authorisation server 102, via communications network 106.

The authentication/authorisation server 102 comprises one or more processors 108 and memory 110 storing instructions (e.g. program code) which when executed by the processor(s) 108 causes the server 102 to manage authentication/authorisation procedures for a user, which may be an individual, a business, or entity, and/or to function according to the described methods. In some embodiments, the security system 100 may operate in conjunction with, or support, one or more servers, such as application server 116, to manage the authentication process and security and in some embodiments, provide a token to the user once authenticated to allow the user to access resources provided by the server(s) 116. For example, the security system 100 may be in communication with the server(s) 116 across the communications network 106.

The processor(s) 108 may comprise one or more microprocessors, central processing units (CPUs), application specific instruction set processors (ASIPs), application specific integrated circuits (ASICs) or other processors capable of reading and executing instruction code.

Memory 110 may comprise one or more volatile or non-volatile memory types. For example, memory 110 may comprise one or more of random access memory (RAM), read-only memory (ROM), electrically erasable programmable read-only memory (EEPROM) or flash memory. Memory 110 is configured to store program code accessible by the processor(s) 108. The program code comprises executable program code modules. In other words, memory 110 is configured to store executable code modules configured to be executable by the processor(s) 108. The executable code modules, when executed by the processor(s) 108 cause the authentication/authorisation server 102 to perform certain functionality, as described in more detail below. For example, memory 110 may comprise an authentication/authorisation module 112 to manage or process requests for authentication, requests for authorisation and/or requests for modifications to access (e.g. log in or log on credentials) and/or requests for modifications to requirements for access credentials, for example. Memory 110 may comprise an event notification emitter module 113 configured to transmit or trigger event notifications to subscribers, such as an event logging engine 120 and/or a security server 150, discussed in more detail below. For example, the event notification emitter module 113 may be configured to monitor for specific events, for example, as may impact or be performed by authentication/authorisation module 112 of the authentication/authorisation server 102, and to transmit event notifications to the subscriber.

The authentication/authorisation server 102 further comprises a communications module 114 to facilitate communications with components of the system 100 across the communications network 106, such as the computing device(s) 104, server(s) 116 and/or other servers (not shown), database 118, event logging engine 120 and/or security server 150, as discussed below. The communications module 114 may comprise a combination of network interface hardware and network interface software suitable for establishing, maintaining and facilitating communication over a relevant communication channel.

The computing device 104 of system 100 may comprise at least one processor 136, one or more forms of memory 138, a user interface 140 and/or a network interface or communications module 142.

Memory 138 may comprise volatile (e.g. RAM) and non-volatile (e.g. hard disk drive, solid state drive, flash memory and/or optical disc) storage. For example, memory 138 may store or be configured to store a number of software applications or applets executable by the processor(s) 136 to perform various device-related functions discussed herein. In some embodiments, activities or functionality performed by the computing device 104 may be reliant on program code served by a system or server, such as authentication/authorisation server 102, and executed by a browser application 144. In some embodiments, memory comprises an authentication application 146 to communicate with the authentication/authorisation server 102 and facilitate the processing of access credential request, for example for verifying or authorising user identity and access to a resource, such as may be provided by an application server 116.

The user interface 140 may comprise at least one output device, such as a display and/or speaker, for providing an output for the computing device 104. The user interface 140 may comprise at least one input device, such as a touch-screen, a keyboard, mouse, microphone, video camera, stylus, push button, switch or other peripheral device that can be used for providing user input to the computing device 104. In some embodiments, the user interface 124 comprises a display, a speaker, a microphone, and/or a video camera.

The communications module 142 may comprise suitable hardware and software interfaces to facilitate wireless communication with the authentication/authorisation server 102, other servers or systems, such as application server 116, other computing devices 104, database 118, logging engine 120 and/or security server 150, for example, over a network, such as communications network 106.

The communications network 106 may include, for example, at least a portion of one or more networks having one or more nodes that transmit, receive, forward, generate, buffer, store, route, switch, process, or a combination thereof, etc. one or more messages, packets, signals, some combination thereof, or so forth. The communications network 106 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

Database 118 may be a relational database for storing information generated, extracted or obtained from authentication/authorisation server 102, client device 104, application server 116, event logging engine 120 and/or by security server 150. In some embodiments, the database 118 may be a non-relational database or NoSQL database. Database 118 may form part of, or be local to, the security system 100, or may be remote from and accessible to the security system 100. The database 118 may be configured to store data associated with the system 100. The database 118 may be configured to store a current state of information or current values associated with various attributes (e.g., “current knowledge”). For example, the database 118 may be configured to store a current state of user credentials associated with a user, such as a user name and password. In some embodiments, the database 118 may be an SQL database comprising tables with a line entry for each user credential information. For example, the line item may comprise entries for a user name, and a user password.

The system 100 further comprises an event logging engine 120 in communication with an event store 122. The event logging engine 120 may be in communication with the authentication/authorisation server 102 and/or the security server 150 across the communications network 106. Event logging engine 120 may comprise communications module 128. The communications module 128 may comprise a combination of network interface hardware and network interface software suitable for establishing, maintaining and facilitating communication over a relevant communication channel.

In some embodiments, the event store 122 may comprise one or a plurality of clusters of event logs. Each event log may be configured to store one or more event streams associated with particular applications and/or systems and/or users. The event store 116 may comprise a set of event logs 124 for the system 100. The event store 116 may comprise a set of compromise logs 134 associated with user accounts that have been compromised or have been subjected to an attempted security breach. Each event log and/or compromise log may be associated with a specific user. The event log comprises one or more event objects, linked in time sequence. The event store 122 and the event logs may be immutable; in other words, the event objects are not updated or changed in any way once they have been appended to the event log.

Event store 122 may comprise compromised logs 134 as a repository of compromised event objects associated with compromised user accounts or potential security breaches. Compromised event objects may be annotated with tags and/or labels indicating their association with a compromised user account and/or attempted security breach. Compromised event objects may comprise features and/or attributes relating to authentication and/or authorisation requests made by users via authentication/authorisation server 102 such as time of request, user role, type of request (e.g. read or write), password strings, email addresses, two-factor authentication information geographical location of the candidate user(s), time zone of the geographical location of the candidate user(s) and/or an identifier of the requesting device, such as IP address or MAC address, for example. User role may be indicative of the role a user is associated with, that requires, obliges and/or otherwise enables the user to gain, use and/or have legitimate reason to request access to the system 100, or any other system that may be in communication with and/or availing of the functionality of system 100. Examples of user roles include but are not limited to: a sole proprietor of an entity, a personal account user, a small entity owner, a moderate entity owner, a large entity owner, an entity manager, a financial expert employed within an entity, and/or a financial services provider.

A user may be required to enter/select or be assigned a role at some point during the account creation and/or access/authorisation process. Users may provide and/or select their role by manually entering their role into a data field during the account creation process. Manually entering a user role may comprise entering text into a text entry field, selecting from a drop down menu, selecting a tick box and/or any other suitable method or system of manually entering data. In some embodiments, user role may be entered by a systems and/or business administrator upon account creation using the same or similar data entry methods as the user, as described above.

In some embodiments, user role may be automatically determined based upon one or more user and/or business or entity attributes. Automatically determining user roles may comprise using a look-up table that may contain user information such as names and/or ID numbers of known employees or system users and their particular role.

One or more compromised event objects may be caused to be transmitted from event logs 124 and stored in compromise logs 134 when a user account is determined by security server 150 to have been compromised or been subjected to an attempted security breach. In some embodiments, upon a determination by a compromised account detection module 170 of the security server 150 that a user account has been compromised or has been subjected to an attempted security breach, the compromised account detection module 170 may communicate a request or instructions to the event logging engine 120 to cause the event object management module 132 to cause event objects associated with the compromised user account to be transmitted or moved from event logs 124 to compromise logs 134. In other embodiments, the security server 150 may comprise a warning module 172, which may be configured to communicate the instructions for event objects to be transmitted or moved to and stored in compromise logs 134.

In some embodiments, event objects may be caused to be transmitted from event logs 124 to compromise logs 134 by system administrators upon becoming aware of a compromised user account or attempted security breach. System administrators may be made aware of compromised user accounts or attempted security breaches via user reports, unusual account behaviour, routine manual security checks and/or security audits, for example.

The event logging engine 120 comprises one or more processors 124 and memory 126 storing instructions (e.g. program code) which when executed by the processor(s) 124 causes the event logging engine 120 to operate according to the described embodiments. The event logging engine 120 may be configured to subscribe to and respond to events, such as real-time events.

Memory 126 of the event logging engine 120 may comprise a subscription module 130 configured to subscribe to events associated with systems, servers and/or computing devices such as authentication/authorisation server 102, computing device(s) 104 and/or application or resource servers 116. In some embodiments, the subscription module 130 may be configured to subscribe to receive event notifications associated with the authentication/authorisation server 102. The subscription module 130 may be configured to receive event notifications from the event notification emitter module 113 of the authentication/authorisation server 102, for example, for events for which it has subscribed.

Memory 126 may comprise an event object management module 132. The event object management module 132 may be configured to respond to, or action, event notifications received by the subscription module 130, or other requests received by the event logging engine 120, such as requests for event objects from security server 150, for example.

In some embodiments, in response to receipt of an event notification (e.g., a write request), such as a change of user credential by a user, or a verification or authentication request by a user, the event object management module 132 may create an object comprising details or information associated with or derived from the event notification, and append the event object to an event log 124 of the event store 122. The event log 124 may be associated specifically with the user.

In some embodiments, in response to a request for information, such as a read request, as, for example, may be received from the authentication/authorisation module 112 of the authentication/authorisation server 102, the event object management module 132 may be configured to identify the event log 124 associated with the particular request, for example using an identifier such as a user identifier, and to replay the event stream, or instances of the event objects of the event log, to determine the relevant data. For example, the read request may relate to a request for a current password, which may be a hashed password associated with the user. The event object management module 132 may be configure to replay the event log of the user to determine the current state of the password and provide the current state of the password to the authentication/authorisation server 102 to allow the authentication/authorisation server 102 to determine if a password entered or provided by the user matches with the current state of the password as provided by the event object management module 132 of the event logging engine 120.

In some embodiments, in response to a request to store or save information, such as a write request, as, for example, may be received from the authentication/authorisation module 112 of the authentication/authorisation server 102, the event object management module 132 may be configured to identify the event log 124 associated with the particular request, for example using an identifier such as a user identifier, and to create an object comprising details or information associated with or derived from the request, and append the event object to an event log 124 of the event store 122.

In some embodiments, the system 100 may operate in conjunction with or support one or more servers, such as application server 116, to manage the authentication process and in some embodiments, provide a token to the user once authenticated to allow the user to access resources provided by the servers 116. For example, the system 100 may be in communication with the server(s) 116 across the communications network 106.

The security server 150 comprises one or more processors 152 and memory 160 storing instructions (e.g. program code) which when executed by the processor(s) 152 causes the security server 150 to manage security procedures for a user, which may be an individual, a business, or entity, the security system 100 and/or to function according to the described methods. In some embodiments, the security server 150 may operate in conjunction with or support one or more servers, such as application server 116, to manage the security requirements and in some embodiments, provide warnings to the application server 116 in the event a compromise or an attempted security breach. For example, the security server 150 may be in communication with the server(s) 116 across the communications network 106.

The processor(s) 108 may comprise one or more microprocessors, central processing units (CPUs), application specific instruction set processors (ASIPs), application specific integrated circuits (ASICs) or other processors capable of reading and executing instruction code.

Memory 160 may comprise one or more volatile or non-volatile memory types. For example, memory 160 may comprise one or more of random access memory (RAM), read-only memory (ROM), electrically erasable programmable read-only memory (EEPROM) or flash memory. Memory 160 is configured to store program code accessible by the processor(s) 152. The program code comprises executable program code modules. In other words, memory 160 is configured to store executable code modules configured to be executable by the processor(s) 152. The executable code modules, when executed by the processor(s) 152 cause the security server 150 to perform certain functionality, as described in more detail below. For example, memory 160 may comprise a data handling module 162, a trigger request module 164, a training module 166, the compromised account detection module 170, representation generation engine 171 and/or the warning module 172.

The data handling module 162 is configured to receive and process data received from event logging engine 120. In some embodiments, responsive to the trigger request module 164 receiving a trigger request, data handling module 162 may be caused to request event objects associated with the user account(s) associated with the trigger request from event logging engine 120. Data handling module 162 may be configured to communicate a candidate user or users to event logging engine 120 by transmitting user account identifier(s) and receive event object(s) associated with the respective user identifier(s).

Subsequent to receiving event object(s) associated with candidate user(s), data handling module 162 may determine from the event object(s) a set of attribute values based on the content of the event objects, such as type of request (e.g. read or write), time of request, user role, password strings, email address(es), two-factor authentication information, geographical location of the candidate user(s), time zone of the geographical location of the candidate user(s) and/or an identifier of the requesting device, such as IP address or MAC address. Data handling module 162 may then communicate the set of attribute values to training module 166 and/or compromised account detection module 170.

In other embodiments, data handling module may be a part of event logging engine 120, or a sub-module of event object management module 132. In such embodiments, data handling module 162 may transmit the datasets and sets of attribute values to security server 150 via communications network 106.

The trigger request module 164 is configured to subscribe to events associated with systems, servers and/or computing devices such as authentication/authorisation server 102, computing device(s) 104, and/or application or resource server 116. The trigger request module 164 may be configured to receive event notifications from the event notification emitter module 113 of the authentication/authorisation server 102, for events for which it has subscribed. In other embodiments, trigger request module 164 may be configured to receive trigger requests in the form of periodic, aperiodic and/or manual instructions to monitor the event logs 124. For example, the trigger request to perform the security operation may comprise receipt of a request from an administrator, or a programmed periodic or aperiodic request.

The training module 166 is configured to train the ML model of the compromised account detection module 170 to detect compromised user accounts and/or attempted security breaches using a training dataset. The training dataset may be stored in database 118, for example. The training dataset may comprise a plurality of compromised user account examples from the compromised account dataset and a plurality of uncompromised user account examples from the uncompromised account dataset. The compromised user account examples may comprise a tag/label indicative of a security risk, and the uncompromised user account examples may comprise a tag/label indicative of no security risk. The compromised and uncompromised user account examples may include features values derived from attribute values of the respective user accounts. In some embodiments, the data handling module 162 may be configured to determine or retrieve the training dataset.

The ML model may be an AI model that incorporate deep learning based computation structures, including artificial neural networks (ANNs). ANNs are computation structures inspired by biological neural networks and comprise one or more layers of artificial neurons configured or trained to process information. Each artificial neuron comprises one or more inputs and an activation function for processing the received inputs to generate one or more outputs. The outputs of each layer of neurons are connected to a subsequent layer of neurons using links. Each link may have a defined numeric weight which determines the strength of a link as information progresses through several layers of an ANN. In a training phase, the various weights and other parameters defining an ANN are optimised to obtain a trained ANN using inputs and known outputs for the inputs. The optimisation may occur through various optimisation processes, including back propagation. ANNs incorporating deep learning techniques comprise several hidden layers of neurons between a first input layer and a final output layer. The several hidden layers of neurons allow the ANN to model complex information processing tasks, including the tasks of determining standard and non-standard user behaviour performed by the system 100.

In some embodiments, ML model may incorporate one or more variants of convolutional neural networks (CNNs), a class of deep neural networks adapted to the various event object processing operations for account compromise detection. CNNs comprise various hidden layers of neurons between an input layer and an output layer to that convolve an input to produce the output through the various hidden layers of neurons.

In some embodiments, the ML model may incorporate one or more variants of recurrent neural networks (RNNs), a class of deep neural networks adapted to exhibit temporal dynamic behaviour, to account for the temporal nature of event objects, attributes, attribute values and/or feature values.

In some embodiments, training module 166 may be deployed on a separate server or system from security system 100. Training module 166 may be configured to transmit the trained ML model to the system 100 via communications network 106 for use in detecting compromised user accounts or attempted security breaches.

The compromised account detection module 170 may comprise the trained ML model. The compromised account detection module 170 may be configured to receive the set of attributes and/or attribute values from data handling module 162 and derive therefrom additional attributes, feature values or numerical representation(s) for providing as inputs to the trained model. In some embodiments, compromised account detection module 170 may use the trained ML model to assess and/or evaluate the features values to determine a status of the candidate user account or account(s). The determination may be in the form of a binary pass fail metric (i.e. compromised or not compromised) or a likelihood determination (e.g. 70% chance of compromise). The compromised account detection module 170 may communicate the determination to warning module 172. Feature values may be attributes indicative of the event objects they are associated with, and may comprise one or more of: authorisation/authentication request type; authorisation/authentication request time; frequency of two or more authorisation/authentication requests; authorisation/authentication request originating location; local time of the authorisation/authentication request originating location; password strings; email addresses; two-factor authentication information user role types; request device identifier; business hours; and/or high network traffic times.

In some embodiments, attributes/attribute values may be extract, calculated, derived or otherwise determined from the one or more event objects. In some embodiment, the feature values may be determined using one or more attribute values. The feature values may be a numerical representation or multi-dimensional vector representation indicative of the attribute values associated with the event objects. In some embodiments, the security server 150 comprises a numerical representation generation engine 171. The numerical representation generation engine 171 may be configured to generate or determine a numerical representation, such as a multi-dimensional vector representation, of the attributes. For example, the numerical representation may comprise the feature values derived from the attributes and/or event objects.

The warning module 172 may be configured to receive the determination from compromised account detection module 170. In some embodiments, warning module 172 may be configured to communicate the determination, for example, in the form of a warning message/communication, to authentication/authorisation server 102, computing device 104, application server 116, database 118 and/or event logging engine 120. The content of the warning message may be responsive to the particular recipient. For example, the warning message may comprise one or more user account identifier, IP address, time stamp and/or time interval, useable by event logging engine 120 to locate specific event objects stored in event logs 124, and cause their communication to and storage in compromise logs 134.

The security server 150 further comprises a communications module 154 to facilitate communications with components of the system 100 across the communications network 106, such as the computing device(s) 104, server(s) 116 and/or other servers (not shown), database 118, event logging engine 120 and/or authentication/authorisation server 102. The communications module 154 may comprise a combination of network interface hardware and network interface software suitable for establishing, maintaining and facilitating communication over a relevant communication channel.

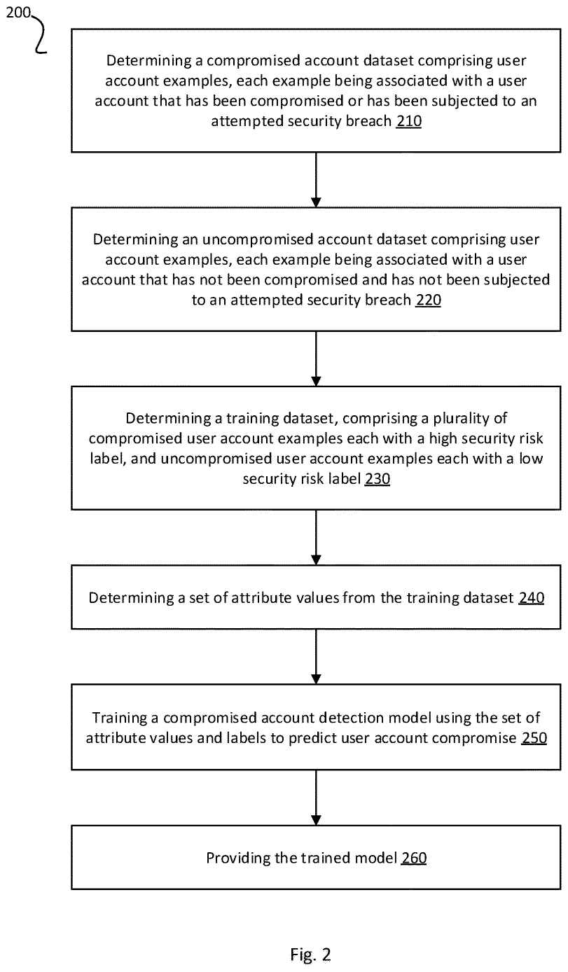

FIG. 2 is a process flow diagram of a method 200 of training a machine learning model to detect compromised accounts and/or attempts to compromise accounts, according to some embodiments. The method 200 may be implemented by the security server 150, for example.

At 210, the security server 150 determines, from an event store 122, a compromised account dataset. The compromised account dataset comprises compromised user account examples, each compromised user account example being associated with a user account that has been compromised or has been subjected to an attempted security breach and each compromised user account example comprising a first plurality of event objects.

In some embodiments, data handling module 162 transmits a request to event logging engine 120 for a plurality of event objects associated with compromised user accounts or accounts subjected to an attempted security breach. The request may be for all stored compromise event objects in compromise logs 132, or it may be a request for a subset of the event objects. The subset of compromise event objects may be determined by a certain required number of event objects and/or event objects within a particular time period, the last 30 days, for example. The request may pertain to event objects associated with all user accounts, a single user account associated with the content of a trigger request, or a subset of user accounts. The subset of user accounts may be determined by the contents of the trigger request and/or attributes associated with an account associated with the trigger request, users who work in a particular business team, for example. Reactive to receiving the request, event logging engine may cause a plurality of compromise event objects to be transmitted to the data handling module 162. The data handling module 162 may determine from the plurality of event objects, a compromised account dataset. The compromised account dataset may be organised first by user account and then by time, for example.

At 220, the security server 150 determines, from the event store 122, a uncompromised account dataset. The uncompromised account dataset comprises uncompromised user account examples, each uncompromised user account example being associated with a user account that has not been compromised and has not been subjected to an attempted security breach, and each uncompromised user account comprising a second plurality of event objects.

In some embodiments, data handling module 162 transmits a second request to event logging engine 120 for the second plurality of event objects associated with uncompromised user accounts or accounts that have not been subjected to an attempted security breach. However, it will be appreciated that the first request may comprise the second request, such that the event logging engine 120 is requested for the first and second pluralities of event objects at the same time.

The request may be for all stored event objects in event logs 132, or it may be a request for a subset of the event objects. The subset of event objects may be determined by a certain required number of event objects and/or event objects within a particular time period, the last 30 days, for example. The request may pertain to event objects associated with all user accounts, a single user account associated with the content of the trigger request, or a subset of user accounts. The subset of user accounts may be determined by the contents of the trigger request and/or attributes associated with an account associated with the trigger request, users who work in a particular business team, for example. Reactive to receiving the second request, event logging engine 120 may cause a plurality of uncompromised event objects to be transmitted to the data handling module 162. The data handling module may determine an uncompromised account dataset. The uncompromised account dataset may be organised first by user and then by time, for example.

At 230, the security server 150 determines a training dataset. The training data set comprises a plurality of compromised user account examples from the compromised account dataset and a plurality of uncompromised user account examples from the uncompromised account dataset. In some embodiments the compromised user account examples may comprise a label indicative of a security risk, and the uncompromised user account examples may comprise a label indicative of no security risk. In some embodiments, the labels may be indicative of standard or non-standard/anomalous authorisation/authentication request behaviours or tendencies.

In some embodiments, the data handling module 162 determines a training dataset from the compromised user account dataset and the uncompromised account dataset. In some embodiments, the data handling module 162 may assign a label or designating tag to each or some of the entries of the compromised user account dataset and each or some of the entries of the uncompromised user account dataset. A label/tag may be assigned to each or some of the entries of the compromised user account dataset indicating a high security risk, and/or a label/tag may be assigned to each or some of the entries of the uncompromised user account dataset indicating a low security risk.

In some embodiments, the compromised user account dataset may be substantially smaller than the uncompromised user account dataset. This is owing to the fact that user account compromise events/attempts may be rare when compared to the totality of user account activity, and accordingly, fewer examples of uncompromised user account may be available.

At 240, the security server 150 determines a set of feature values from each of the plurality of compromised user account examples and the plurality of uncompromised user account examples. For example, the set of feature values may be determined or derived from attributes of the compromised and uncompromised user account examples.

In some embodiments, data handling module 162 determines from the training dataset a set of attribute values. In some embodiments, one or more of the attribute values of the set of attribute values may be indicative of non-standard or anomalous behaviours of one or more users, as recorded by requests sent to the authentication/authorisation server 102. In some embodiments, one or more of the attribute values of the set of attribute values may be indicative of standard behaviours of one or more users, as recorded by requests sent to the authentication/authorisation server 102. Standard behaviours may constitute actions taken by one or more users that are substantially similar to their regular actions.

Standard behaviours may constitute actions taken by one or more users that are substantially similar to their regular actions and non-standard behaviours may constitute actions taken by one or more users that are different from (i.e. not substantially similar) or anomalous to their regular actions. Anomalous behaviour may be any behaviour that deviates from what is standard, normal, or expected behaviour. Regular actions may comprise actions that are repeated over an extended amount of time. Regular actions may also comprise actions that are expected or typical, by one or more metrics, or conforms to a pre-existing standard. Expected or typical actions may be defined by prior actions taken by: one or more users previous actions, metrics established by entities that interact with or otherwise make us of the system 100 and/or any other system that may meaningfully differentiate between expected and unexpected and/or typical and atypical actions. The one or more metrics and the pre-existing standard may be defined by time, user role, and/or specifically defined business/entity metrics/standards. Regular actions may also be dependent on time of day, and/or time zones, for example, requesting access to a user account several times in quick succession may be a regular or irregular actions, depending on whether the requests were submitted during or outside of business hours.

Regular actions may also vary across a user's role. A user's role, for example, may be their role as a member of a business or entity, their role as an owner of a personal account, their role as an owner of a business account, or any other role that may require the user to interact with the system 100, or any other system that the system 100 may in communication with. An example of a user's role impacting what may constitute regular actions is, a first user in a small business role may only request access to their account once a week, while a second user in an employment role may request access to numerous different user accounts multiple times in a day, to perform the duties associated with their employment role.

Non-standard or anomalous behaviours may be indicative of when a user account has been successfully compromised or when the user account has been or is being subjected to an attempt to compromise an account. The attribute values may be number of authentication/authorisation requests, time of authentication/authorisation requests, frequency of authentication/authorisation requests, time of authentication/authorisation requests, IP addresses of authentication/authorisation requests, password strings, email addresses and/or password string tendencies, for example. The attribute values may also be controlled, filter and/or curated to be indicative of time of day and/or regular business hours of a business or entity and/or be controlled for user role, or user geographic location.

In some embodiments, when the compromised account examples are substantially less numerous than the uncompromised account examples, security server 150 may perform data resampling to attempt to better balance the data. Resampling may comprise one or more of random under-sampling, random over-sampling, clustered data balancing, under sampling using tomek links and/or synthetic minority oversampling technique (SMOTE).

In some embodiments, the attribute features may comprise, the time of an authentication/authorisation request, business hours associated with the entity or user account the authentication/authorisation request is associated with, one or more user roles the authentication/authorisation request is associated with and/or periods of high activity associated with one or more of the user account the authentication/authorisation request is associated with or the entity the authentication/authorisation request is associated with, for example.

At 250, the security server 150 trains a compromised account detection model, such as a ML model, using the sets of attribute values and associated labels to predict a likelihood of a candidate user account being a security risk.

In some embodiments, the training process may comprise a semi-supervised training approach. The semi-supervised training approach may comprise using a dataset of both labelled and unlabelled data. For example, the training dataset may comprise a small number of labelled data and a large number of unlabelled data, such as a relatively small number of compromised account data labelled as being indicative of a compromised account or attempt to compromise an account and a relatively small number of uncompromised account data. The training dataset may also comprise a large number of unlabelled data, which may contain both compromised and uncompromised account data, but with no associated tag/label.

In some embodiments, the semi-supervised training approach may be a self-training approach. Wherein an initial ML model is trained on the small collection of labelled data to create a first classifier, or base model. The first classifier may then be tasked with labelling one or more larger unlabelled datasets to create a collection of pseudo-labels for the unlabelled dataset. The labelled dataset is then combined with a selection of the most confident pseudo-labels from the pseudo-labelled dataset to create a new fully-labelled dataset. The most confident pseudo-labels may be hand selected, or determined by the ML model. The new fully-labelled dataset is then used to train a second classifier, which by nature of having a larger labelled training dataset may exhibit improved classification performance compared to the first model. The above-described process may be repeated any number of times, with more times generally resulting in a better performing classifier.

In some embodiments, the semi-supervised training approach may be a co-training approach, wherein two first classifiers are initially trained simultaneously on two different labelled data sets or ‘views’, each labelled data set comprising different features of the same instances. For example, one dataset may comprise user account authentication/authorisation requests, and one may comprise user account password change requests. In this approach each set of features is sufficient for each classifier to reliably determine the class of each instance.

Subsequent to the initial training of the two first classifiers, the larger pool of unlabelled data may beseparated into the two different views and given to the first classifiers to receive pseudo-labels. Classifiers co-train one another using pseudo-labels with the highest confidence level. If the first classifier confidently predicts the genuine label for a data sample while the other one makes a prediction error, then the data with the confident pseudo-labels assigned by the first classifier updates the second classifier and vice-versa. Finally, the predictions are combined from the updated classifiers to get one classification result. As with the self-training approach, this process may be repeated iteratively to improve classification performance.

In some embodiments, training the ML model may use a deep generative model to compensate for the imbalance between the compromised and uncompromised user account datasets. Generative models treat the semi-supervised learning problem as a specialised missing data imputation task for the classification problem, effectively treating data imbalance as a classification issue instead of an input issue. Generative models utilise a probability distribution that may determine the probability of an observable trait, given a target determination. Generative models have the capability to generate new data instances based upon previous data instances, to aid in training better performing models for datasets with limited labels.

In some embodiments, the generative model may be a generative adversarial network (GAN). The GAN may comprise a generator model and a discriminator model. The generator model may generate a batch of synthetic data, and this data, along with the real examples from the account dataset, are provided to the discriminator model and classified as real or fake. The discriminator model may then be updated to improve its ability to discriminate between real and fake (i.e. synthetic) samples in the next round, and importantly, the generator model is updated based on how well, or not, the generated samples fooled the discriminator model.

In some embodiments, the generative model may be a variational auto-encoder (VAE). The VAE may comprise an encoder model and a decoder model, wherein the encoder converts an input into a set of latent attributes, (e.g. a probabilistic distribution) of the input, and the decoder is tasked with recreating the input based on the received latent attributes(i.e. decoding the latent attributes).

In some embodiments, the ML model training process may use a sliding window data selection approach to account for time variant event data, such as business hours, or to account for rates of access, such as large numbers of account authentication/authorisation requests over a small amount of time. The ML model may be configured to shift the observation window and/or vary the size of the observation window to include/exclude various data to improve the ability of the ML model to classify instances. For example, to determine standard behaviour of a user, the ML model may be configured to shift and resize the sliding window to only capture activity that occurs within business hours. In a further example, to determine non-standard behaviour, which may be indicative of a account comprise event or attempt, the ML model may be configured to shift and resize the sliding window to capture particular times of day, periods of high activity, (e.g. small periods of time with large numbers of sequential and/or temporally proximal event objects), and/or user roles.

In some embodiments, the sliding window data selection may be utilised to select training data on a dynamic basis, wherein the sliding window assess and/or curates each input as it is provided to the ML model during the training process to create one or more feature value subsets, to thereby improve the classification ability of the ML model. The assessment and/or curation of the inputs may be dependent on a predefined set of criteria, such as times, days, and/or feature values. In some embodiments, the assessment and/or curation of the inputs may be dependent on one or more previous or future inputs. For example, the sliding window may determine that the most recent input occurred during business hours, and adjust the size and/or position of the sliding window to only capture inputs that occur during business hours until a predetermined input threshold is reached, and/or no more examples that fit into the sliding window are available.

In some embodiments, the sliding window may be configured to assess and/or curate the compromised account examples and/or the uncompromised account examples, to determine one or more user account subsets. The assessment and/or curation of the account examples may use the same criteria as the assessment and/or curation of the ML inputs, as described above. One or more feature values subsets may subsequently be determined from the one or more user account subsets, for use in training the ML model.

Features indicative of user attributes and/or behaviours, which may be derived from the event objects of a respective user, can be represented as a numerical or multi-dimensional vector representation for the user. In other words, the numerical representation or multi-dimensional vector representation is indicative of the one or more event objects and/or the user attributes and/or behaviour represented by the one or more event objects. For example, the security server 150 may comprise a numerical representation generation engine 171 configured to determine a numerical representation of the features. In some embodiments, the numerical representation generation engine 171 may determine a numerical representation of one more attribute values and/or feature values which is indicative of one or more event objects associated with an uncompromised or compromised user account and/or standard or non-standard/anomalous user behaviour. In some embodiments, the feature values determined from the attribute values may be a numerical representation of the one or more event objects that attribute values are associated with.

In some embodiments, the numerical representation generation engine 171 may be configured to convert the features into a numerical representation using a one-hot/one-of-k scheme. Converting the data into a one-hot/one-of-k scheme may comprise converting categorical integer features, i.e. feature values such as authentication/authorisation request type, authentication/authorisation request time, password strings, email addresses, two-factor authentication information and/or request IP address, into a categorical value. The categorical value represents the numerical value of the entry in the dataset.

In some embodiments, the order or sequence of user authentication/authorisation requests may be indicative of a compromised or uncompromised account, and/or standard or non-standard user behaviour. In this instance, a sequence of event objects may be a feature that is used as an input for the ML model. The numerical representation generation engine 171 of the security server 150 may convert one or more event objects and/or attributes features into an ordinal encoding. In some embodiments, the ordinal encoding may be performed by a publically available machine learning library, such as the scikit-learn Python machine learning library via the OrdinalEncoder class, or any other publically available ML library. In other embodiments, the ordinal encoding process may also be performed by the security server 150, using an encoding method configured specifically for encoding event objects and/or attribute features.

In some embodiments, the numerical representation generation engine 171 is configured to determine word embeddings based on the data associated with event objects and/or the attribute features. Embedding is a process by which individual words are represented as real-valued vectors in a predefined vector space. By distributing the representations across the vector space, words with similar meanings and/or that are used in similar ways result in being spatially closer to each other, thereby capturing their meaning.

The security server 150 may use collected or determined user roles during the ML model training process. In some embodiments, the security server 150 may train one or ML model for each user role. In the instance that a user has two or more roles, the security server 150 may train one ML model for every user role and/or combination of two or more user roles thereof. The security server 150 may select from the training data the event logs that are associated with one, or a particular combination of two or more user roles, such as a personal account holder, or a personal account holder who is also a small business owner, for example. The security server 150 may use the role specific event logs to determine role specific feature values to use to train the ML model. When training role specific ML models, the security server 150 may use any one or more of the training processes described herein.

In some embodiments, the security server 150 may only train one ML model for all user roles. The ML training model may use user roles as an input. The security server 150 may use one or more training approaches, such as the sliding window selection approach, to control for variations across different user roles.

At 260, the security server 150 provides the trained compromised account detection model, which can be deployed for use. In some embodiments, the model is provided to a compromised account detection module 170 for use in detecting compromised user accounts or attempted security breaches of security system 100. In other embodiments, training module 166 may be deployed on a separate system/server from security system 100, and the trained model may be provided to security server 150 via communications network 106, or in any suitable manner.

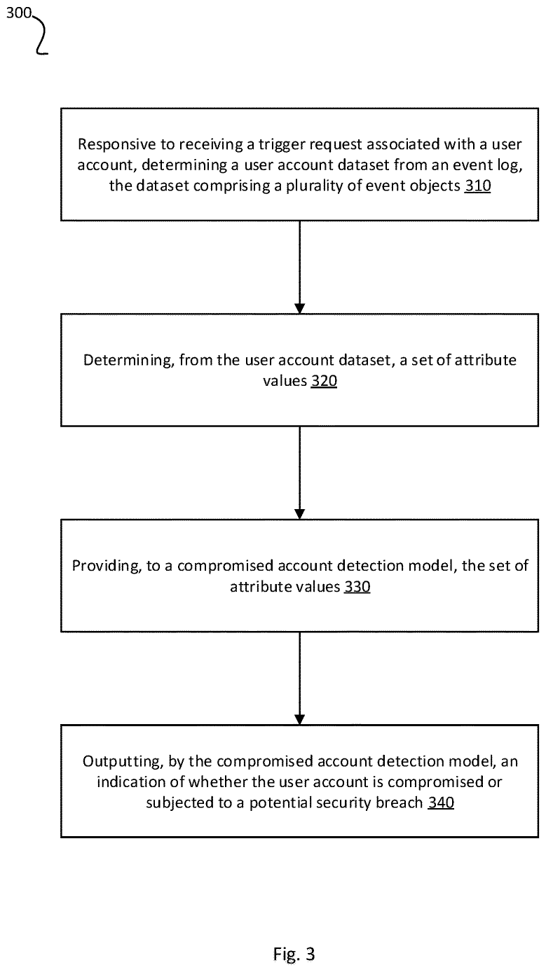

FIG. 3 is a process flow diagram of a method 300 for detecting compromised accounts and/or attempts to compromise accounts, according to some embodiments. The method 300 may be implemented by the security server 150. The method 300 may use the trained compromised account detection model, trained according to the method 200 described above.

At 310, the security server 150, in response to receiving a trigger request associated with a user account, determines, from an event log of the user account at an event store, a user account dataset. The user account dataset comprises a plurality of event objects.

In some embodiments, the trigger request module 164 receives a trigger request that has been sent from event notification emitter module 113. The trigger request may be a request by a user of the system 100 to access user authentication credentials, or it may be a periodic or aperiodic request by the system 100, or an administrator of the system 100 to check the security status of the user accounts. Trigger request module 164, subsequent to receiving the trigger request, may cause data handling module 162 to request from event logging engine 120 a plurality of event objects stored in event store 122. The plurality of event objects may be associated with the user account that sent the user request, or the one or more user account nominated by the period/aperiodic system request or system administrator request. The data handling module 162 may compile the requested plurality of event objects into a discrete user account dataset.

In some embodiments, event logging engine 120 may comprise data handling module, and the trigger request module 164 may be a part of subscription module 130. Subscription module 130 may be configured to receive the trigger request from event notification emitter module 113 and subsequently cause data handling module 162 to transmit the plurality of event objects to the security server 150 via communications network 106.

At 320, the security server 150 determines from the plurality of event objects, a set of or one or more feature values. For example, the one or more feature values may be determined or derived from attributes of the user account dataset.

In some embodiments, the data handling module 162 determines from the user account dataset the set of attribute values. For example, the set of attribute values may be derived from the content of the plurality of event objects. The content of the plurality of event objects may comprise type of request (e.g. read or write), time of request, user role, password strings, email addresses, two-factor authentication information and/or request IP address. The set of attribute values determined by the data handling module 162 from the user account dataset may comprise: number of requests, rate of requests, average type of request (e.g. read or write), password generation tendencies, number and/or type of account information changes and/or request IP addresses. The set of attribute values may be indicative of the authorisation request behaviour associated with the user account or accounts that are associated with the plurality of event objects.

In some embodiments, one or more feature values indicative of the event objects and/or user behaviour associated with the one or more event objects may be determined from the set of attribute values. For example, the numerical representation generation engine 171 may determine a numerical representation, such as a multi-dimensional vector representation, comprising the feature values. The one or more feature values may be numerical representations or multi-dimensional vector representations, indicative of the event objects and/or user behaviour associated with the one or more event objects

At 330, the security server 150 provides, to a compromised account detection model, the set of feature values, or a numerical representation of the set of feature values. The compromised account detection model is configured to predict user account security risks based on set of feature values. In some embodiments, the compromised account detection model is configured to classify whether the authentication/authorisation request behaviour associated with the user account or accounts is standard or non-standard/anomalous, when compared to previous behaviour or one or more behavioural metrics.

In some embodiments, the data handling module 162 provides the set of attribute values to the compromised account detection module 170. The compromised account detection module 170, and in some embodiments, the numerical representation generation engine 171, is configured to determine the set of feature values from the set of attribute values. The compromised account detection module 170 determines, from the feature values or the numerical representation of the feature value, whether the account(s) associated with the associated attribute values is compromised or has been subjected to an attempted security breach. In some embodiments, the compromised account detection module 170 is configured to determine the compromised or uncompromised status by determining if user authentication/authorisation request behaviour is non-standard/anomalous or standard, respectively. The compromised account detection module 170 may comprise a machine learning (ML) model trained to detect compromise indicators based on the set of feature values. The compromise indicators may be any one or more indicators that are indicative of standard or non-standard user authentication/authorisation request behaviour. In some embodiments, the ML model may be trained according to the method 200, as described above.

In some embodiments, to determine user account security risks, the ML model may be configured to implement a sliding window data selection process. This sliding window data selection process may comprise including or excluding nodes, weights, data points, and/or any other constituent element of the ML model to account for variations in the set of feature values. For example, the features values or numerical representation provided to the ML model may comprise timestamp information indicating a time at which each event object was recorded. The timestamp may be indicative of whether the event object was recorded during predetermined business hours, such as business hours associated with a certain predetermined user role. The sliding window may then accordingly exclude nodes, weights, data points and/or any other constituent element of the ML model that are not related to, associated with, or indicative of behaviours that occur outside of business hours. In some embodiments, where event objects or series and/or sets of event objects are represented by an embedding representation, the and the proximity of the embedding representing the provided set of feature values is indicative of standard or non-standard/anomalous behaviours, the sliding window may be configured to include or exclude one or more embedding representation to control for data variation, such as time of day, user role and/or type of authorisation/authentication request.

At 340, the account compromise detection module outputs an indication of whether the user account(s) have been compromised or have been subjected to a potential security breach. In some embodiments, the indication of whether the user account(s) have been compromised or have been subjected to a potential security breach may comprise or be based on an indication that a user's authentication/authorisation request behaviour is standard or non-standard, when compared to their behaviour as defined by previous event objects associated with the candidate user account, or by one or more metrics.

In some embodiments, the indication may be communicated to warning module 172, which may then communicate a security warning to one or more of the authentication/authorisation server 102, computing device 104, event logging engine 120 and/or application server 116. Upon receipt of the security warning, one or more of the authentication/authorisation server 102, computing device 104, event logging engine 120 and/or application server 116 may be caused to take reactionary and/or precautionary actions. Authentication/authorisation server 102 may cause the candidate account(s)/user(s) to be temporarily or permanently deactivated, computing device 104 may cause the security warning to be caused to appear on the user interface 142, event logging engine 120 may cause the event objects associated with the compromise or potential security breach to be stored in compromise logs 134, database 118 may log the security warning and/or application server 116 may issue an additional security warning to users of its services.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method comprising:
determining, from an event store, a compromised account dataset comprising compromised user account examples, each compromised user account example being associated with a user account that has been compromised or has been subjected to an attempted security breach, and comprising a first plurality of event objects;
determining, from the event store, an uncompromised account dataset comprising uncompromised user account examples, each uncompromised user account example being associated with a user account that has not been compromised and has not been subjected to an attempted security breach, and comprising a second plurality of event objects;
determining a training dataset, the training data set comprising a plurality of compromised user account examples from the compromised account dataset and a plurality of uncompromised user account examples from the uncompromised account dataset, wherein one or more of the compromised user account examples comprise a label indicative of a security risk, and one or more of the uncompromised user account examples comprise a label indicative of no security risk;
determining a set of attributes from each of the plurality of compromised user account examples and the plurality of uncompromised user account examples;
determining a numerical representation of each set of attributes, wherein at least some numerical representations are associated with the respective label of the compromised or uncompromised user account examples from which the associated set of attributes was determined;
training a compromised account detection model using the numerical representations and the labels to predict a likelihood of a candidate user account being a security risk; and
providing the trained compromised account detection model,
wherein the set of attributes comprises a user role type attribute, and the user role type attribute comprises a dual or multi role value.

2. The computer-implemented method of claim 1, wherein user accounts of the user account examples of the compromised account dataset and the uncompromised account dataset are associated with a same user role type attribute.

3. The computer-implemented method of claim 1, wherein user accounts of the user account examples of the compromised account dataset and the uncompromised account dataset are associated with a plurality of different user role type attributes.

4. The computer-implemented method from claim 3, wherein a first feature value of each of the numerical representations of the plurality of compromised user account examples and the plurality of uncompromised user account examples is a role type attribute value.

5. (canceled)

6. The computer-implemented method of claim 1, wherein the set of attributes determined from the uncompromised user account examples are indicative of standard user behaviours for the user role type attribute and the set of attributes determined from the compromised user account examples are indicative of non-standard and/or anomalous user behaviours for the user role type attribute.

7. The computer-implemented method of claim 1, wherein the training of the compromised account detection model comprises:
an adaptive sliding window data selection method.

8. The computer-implemented method of claim 7, wherein the adaptive sliding window selection method comprises:
determining one or more account example subsets of the uncompromised account dataset and/or the compromised account dataset; and
determining one or more attribute subsets from each of the plurality of compromised user account examples and each of the plurality of uncompromised user account examples in the one or more account example subsets.

9. The computer-implemented method of claim 7, wherein the adaptive sliding window selection method comprises:
determining one or more attribute subsets of the set of attributes.

10. The computer-implemented method of claim 9, wherein the one or more attribute subsets are determined based on one or more of: time of day, business hours, user role type and/or periods of high activity.

11. The computer-implemented method of claim 8, wherein the compromised account detection model is trained using the one or more attribute subsets.

12. (canceled)

13. The computer-implemented method of claim 1, wherein determining the numerical representation of each set of attributes comprises:
encoding one or more of the attributes into an ordinal encoding, wherein the ordinal encoding is indicative of a sequential relationship between each of the plurality of compromised user account examples and wherein the ordinal encoding is indicative of a sequential relationship between each of the plurality of uncompromised user account examples.

14. The computer-implemented method of claim 1, further comprising:
generating one or more artificial compromised account examples using a generative machine learning model.

15. A computer-implemented method comprising:
responsive to receiving a trigger request associated with a user account, determining, from an event log of the user account at an event store, a user account dataset, the user account dataset comprising a plurality of event objects;
determining, from the plurality of event objects, a set of attributes;
determining a numerical representation of the set of attributes;
providing, to a compromised account detection model, the numerical representation, the compromised account detection model configured to predict user account security risks; and
outputting, by the compromised account detection model, an indication of whether the user account is compromised or whether the user account has been subjected to a potential security breach,
wherein the set of attributes comprises a user role type attribute, and the user role type attribute comprises a dual or multi role value.

16. The computer-implemented method of claim 15, wherein a first feature value of the numerical representation comprises an indication of a user role type attribute value.

17. The computer-implemented method of claim 15, further comprising:
determining a user role type attribute value associated with the user account; and
selecting the compromised account detection model from a plurality of compromised account detection models based on the user role type attribute value, wherein the selected compromised account detection model is configured to output an indication of whether the user account is compromised or whether the user account has been subjected to a potential security breach specific to the determined user role type attribute.

18. (canceled)

19. (canceled)

20. The computer-implemented method of claim 15, wherein the trigger request is one of:
an access credential request;
an automatic compromised account check request; or
a manual compromised account check request.

21. The computer-implemented method of claim 15, wherein the compromised account detection model is trained by performing operations including:
determining, from an event store, a compromised account dataset comprising compromised user account examples, each compromised user account example being associated with a user account that has been compromised or has been subjected to an attempted security breach, and comprising a first plurality of event objects;
determining, from the event store, an uncompromised account dataset comprising uncompromised user account examples, each uncompromised user account example being associated with a user account that has not been compromised and has not been subjected to an attempted security breach, and comprising a second plurality of event objects;
determining a training dataset, the training data set comprising a plurality of compromised user account examples from the compromised account dataset and a plurality of uncompromised user account examples from the uncompromised account dataset, wherein one or more of the compromised user account examples comprise a label indicative of a security risk, and one or more of the uncompromised user account examples comprise a label indicative of no security risk;
determining a set of attributes from each of the plurality of compromised user account examples and the plurality of uncompromised user account examples;
determining a numerical representation of each set of attributes, wherein at least some numerical representations are associated with the respective label of the compromised or uncompromised user account examples from which the associated set of attributes was determined;
training a compromised account detection model using the numerical representations and the labels to predict a likelihood of a candidate user account being a security risk; and
providing the trained compromised account detection model, wherein the set of attributes comprises a user role type attribute, and the user role type attribute comprises a dual or multi role value.

22. The computer-implemented method of claim 1, wherein the set of attributes comprise or are indicative of one or more of:
authentication/authorisation request type;
authentication/authorisation request time;
authentication/authorisation request frequency;
authentication/authorisation request originating location;
local time of the authentication/authorisation request originating location;
password strings;
email addresses;
two-factor authentication/authorisation information;
request device identifier;
business hours; and
high network traffic times.

23. A system comprising:
memory having instructions embodied thereon; and
one or more processors configured by the instructions to perform operations including:
determining, from an event store, a compromised account dataset comprising compromised user account examples, each compromised user account example being associated with a user account that has been compromised or has been subjected to an attempted security breach, and comprising a first plurality of event objects;
determining, from the event store, an uncompromised account dataset comprising uncompromised user account examples, each uncompromised user account example being associated with a user account that has not been compromised and has not been subjected to an attempted security breach, and comprising a second plurality of event objects;
determining a training dataset, the training data set comprising a plurality of compromised user account examples from the compromised account dataset and a plurality of uncompromised user account examples from the uncompromised account dataset, wherein one or more of the compromised user account examples comprise a label indicative of a security risk, and one or more of the uncompromised user account examples comprise a label indicative of no security risk;
determining a set of attributes from each of the plurality of compromised user account examples and the plurality of uncompromised user account examples;
determining a numerical representation of each set of attributes, wherein at least some numerical representations are associated with the respective label of the compromised or uncompromised user account examples from which the associated set of attributes was determined;
training a compromised account detection model using the numerical representations and the labels to predict a likelihood of a candidate user account being a security risk; and
providing the trained compromised account detection model,
wherein the set of attributes comprises a user role type attribute, and the user role type attribute comprises a dual or multi role value.

24. A non-transitory machine-readable storage medium storing instructions which, when executed by one or more processors, cause the one or more processors to perform operations including:
determining, from an event store, a compromised account dataset comprising compromised user account examples, each compromised user account example being associated with a user account that has been compromised or has been subjected to an attempted security breach, and comprising a first plurality of event objects;
determining, from the event store, an uncompromised account dataset comprising uncompromised user account examples, each uncompromised user account example being associated with a user account that has not been compromised and has not been subjected to an attempted security breach, and comprising a second plurality of event objects;
determining a training dataset, the training data set comprising a plurality of compromised user account examples from the compromised account dataset and a plurality of uncompromised user account examples from the uncompromised account dataset, wherein one or more of the compromised user account examples comprise a label indicative of a security risk, and one or more of the uncompromised user account examples comprise a label indicative of no security risk;
determining a set of attributes from each of the plurality of compromised user account examples and the plurality of uncompromised user account examples;
determining a numerical representation of each set of attributes, wherein at least some numerical representations are associated with the respective label of the compromised or uncompromised user account examples from which the associated set of attributes was determined;
training a compromised account detection model using the numerical representations and the labels to predict a likelihood of a candidate user account being a security risk; and
providing the trained compromised account detection model,
wherein the set of attributes comprises a user role type attribute, and the user role type attribute comprises a dual or multi role value.
